(19) United States
(12) Patent Application Publication
(10) Pub. No.: US 2005/0258020 A1
(43) Pub. Date: Nov. 24, 2005

(54) Button array

(76) Inventor: Esa Etelapera, Tampere (FI)

Correspondence Address: Hollingsworth & Funk, LLC, Suite 125, 8009 34th Avenue South, Minneapolis, MN, 55425, US

(21) Appl. No.: 10/852,496

(22) Filed: May 24, 2004

(51) Int. Cl. H01H 9/00

(52) U.S. Cl. 200/5 A

(57) ABSTRACT

A mobile device and a button array system. The mobile device comprises a button array, having predetermined dimensions, said array comprising: a plurality of miniature switch elements arranged at distances shorter than those suited for button activation by an operator pressing a button with his/her finger. The size and number of buttons in said array is arranged to be exchangeable on the basis of the application of said button array. A display is arranged in the vicinity of the button array, said display being arranged to show label(s) of the commands available with the button array. The mobile device also comprises means for identifying the midmost switch element(s) activated by the operator. The invention also relates to a computer program and a computer program product.

### FIELD OF THE INVENTION

The invention relates to a user interface of mobile devices, and especially to mobile devices comprising a display and a button array, as well as to button array systems to be arranged in the vicinity of the display of a mobile device.

### BACKGROUND OF THE INVENTION

Prior art knows mobile devices that have displays for displaying visual information to a user. In this context, ‘mobile devices’ refer to cellular phones, communicators, other PDA (Personal Digital Assistant) devices, hand-held game decks and similar devices, the special characteristics of which include low weight and small size.

In known mobile devices, such as Nokia communicator products, the main command inputting is implemented by using four hardware command buttons on the right side of the main display. Associated command text labels are shown on the main display, on its right-hand part. The number of the command buttons is fixed to four.

The above arrangement involves problems in that in some situations only a subset of buttons is in use, and, on the other hand, in some other situations it would be useful to have more command buttons available. It is known to solve the first problem by leaving extra buttons unlabeled, i.e. unused. The second problem has been solved earlier by including a “More” command in one of the command buttons. When pressed, this command presents a secondary command set. The solutions presented are not perfect in view of accessibility of mobile devices.

Additionally, due to the fact that the amount of command buttons is fixed, a perfect software implementation is possible only on mobile devices that have the same number of command buttons in use.

### SUMMARY OF THE INVENTION

Thus, an object of the invention is to provide a button array/selection key system and a mobile device for eliminating the aforementioned and other problems.

The invention relates to a button array system to be arranged in the vicinity of the display of a mobile device, the button array system having predetermined dimensions, wherein the size of the buttons in said array is arranged to be exchangeable on the basis of the purpose of use of said button array.

The invention also relates to a button array system having a predetermined width and height, said array comprising: a plurality of miniature switch elements arranged at distances shorter than those suited for button activation by an operator pressing a button with his/her finger, means for identifying the midmost switch element(s) activated by the operator, and means for identifying the button event associated with said midmost switch element(s).

The invention further relates to a mobile device, comprising:
a display and a button array, the button array having a predetermined width and height, wherein the size of the buttons in said array is arranged to be exchangeable on the basis of the purpose of use of said button array, wherein the button array is arranged in the vicinity of the display, and wherein the display is arranged to show the labels of commands available with the button array and the application executed in the mobile device.

The invention is further related to a mobile device comprising:
a button array having predetermined dimensions, said array comprising a plurality of miniature switch elements arranged at spacings which are less in value than a value which is suited for button activation by the operator when using his/her finger,
means for identifying the midmost switch element(s) activated by the operator and
means for identifying the button event associated with said midmost switch element(s).

The invention still further relates to a mobile device comprising:
a button array having predetermined dimensions, said array comprising a plurality of miniature switch elements arranged at distances shorter than those suited for button activation by an operator pressing a button with his/her finger,
a display arranged in the vicinity of the button array, said display being arranged to show the label(s) of commands available with the button array,
means for identifying the midmost switch element(s) activated by the operator,
wherein the size and number of the buttons in said array is arranged to be exchangeable on the basis of the application of said button array.

The invention still further relates to a computer program which is loadable into the internal memory of a mobile device, the mobile device comprising a button array having predetermined dimensions and comprising a plurality of miniature switch elements arranged at distances shorter than those suited for button activation by an operator pressing a button with his/her finger,
wherein said computer program comprises a software code for
identifying the midmost switch element(s) activated by the operator and for
identifying the button event associated with said midmost switch element(s).

The invention still further relates to a computer program product comprising a computer program for a mobile device, the mobile device comprising a button array, having predetermined dimensions and comprising a plurality of miniature switch elements arranged at distances shorter than those suited for button activation by an operator pressing a button with his/her finger,
wherein said computer program comprises a software code for
identifying the midmost switch element(s) activated by the operator and for
identifying the button event associated with said midmost switch element(s).

An advantage of the system and the mobile phone according to the invention is that they allow a flexible, or non-fixed, size of buttons or keys to be provided. Therefore it is possible to arrange the number and size of the buttons in an optimal way on the basis of the respective application in the mobile phone.

Another advantage is that the number of buttons can be adapted to the requirements of the application software. Therefore, there is much more freedom to draft user-friendly software.

### BRIEF DESCRIPTION OF THE DRAWINGS

A more detailed disclosure of the invention is provided by the following description of preferred embodiments given by way of example and to be understood in conjunction with the accompanying drawings wherein:

FIG. 1 shows a schematic perspective view of an embodiment of a mobile device according to the invention,

FIG. 2 shows a schematic front view of a detail of the mobile device shown in FIG. 1,

FIG. 3 shows a schematic, partly sectional side view of the button array shown in FIG. 1 and FIG. 2, and

FIG. 4 shows a schematic front-view of a detail of another embodiment of the mobile device according to the invention.

### DETAILED DESCRIPTION OF EMBODIMENTS OF THE INVENTION

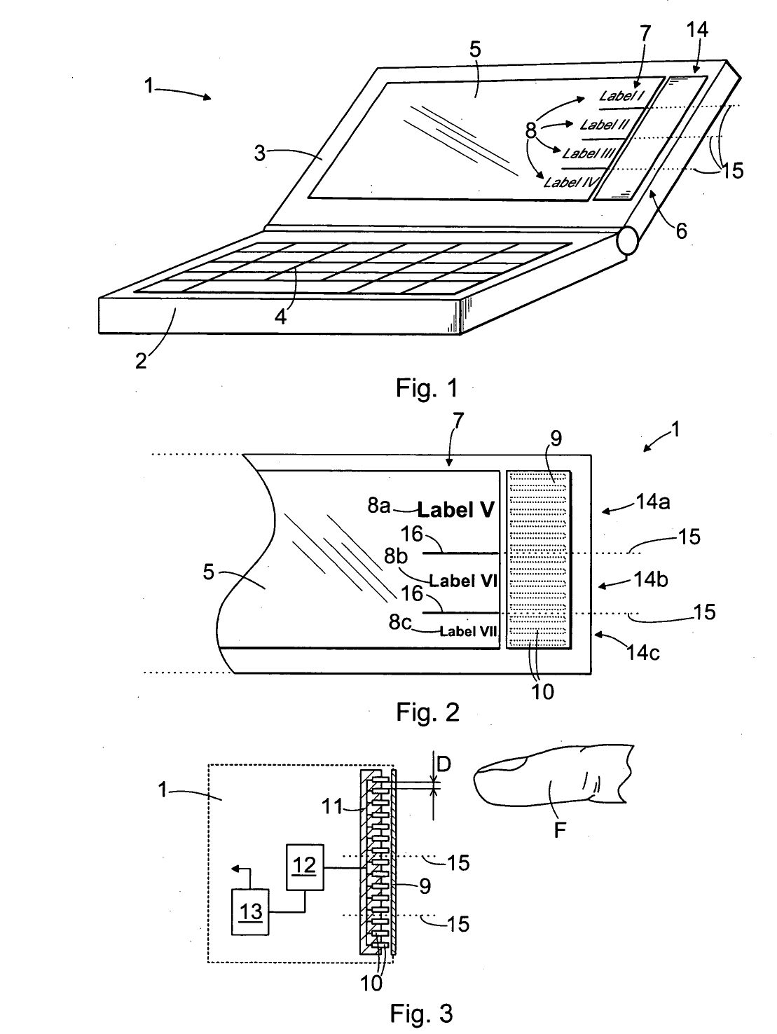

FIG. 1 is a schematic perspective view of an embodiment of the mobile device according to the invention, FIG. 2 is a schematic front view of a detail of the mobile device shown in FIG. 1, and FIG. 3 is a schematic, partly sectional side view of the button array shown in FIG. 1.

The mobile device 1 shown in FIGS. 1 and 2 is a communicator type of cellular phone. The cellular phone comprises a base part 2 and a cover part 3 which are arranged to turn with respect to each other by a hinge structure, which is not shown in the figures to simplify the illustration. The base part 2 comprises the keyboard 4 of the phone and the cover part 3 a display 5, but the components can also be arranged otherwise.

The display 5 is a liquid crystal display (LCD), for example, and its shape is rectangular: the right and left edges are shorter than the upper and lower edges. The type of the display 5 can also be other than LCD, such as OLED (Organic Light Emitting Diode) or FED (Field Effect Display), and its shape can vary from the shape shown in the figures.

On the right side of the display 5 there is arranged a button array 6 in the vicinity of the right edge of the display 5. The button array 6 has an oblong shape and in the embodiment the height of the array is essentially equal to the height of the display. It is to be noted that the button array 6 may have some other shape, too.

In the display 5, on its right side, there is an area 7 for command labels 8 arranged one after the other. The command labels 8 indicate to the user of the phone those functions that can be carried out in the current application of the phone by using the button array 6. Said functions can be denoted, for instance, by text, alphabetical or numerical characters, figures, symbols or some other visual signs. It is to be noted in this connection that “in the vicinity of the display” means that the command labels 8 and the button array 6 are so close to each other that there is no difficulty for the user of the phone to quickly associate the command labels 8 to the button array 6.

There are four labels 8 in the command label area 7 in FIG. 1. This means that those four commands or functions indicated in the command labels 8 can be executed by pressing the button array 6.

As shown in FIG. 3, the button array 6 comprises a covering element 9 which is arranged to form a contact surface of the button array 6. The covering element 9 is made of a flexible, non-transparent material, but it can also be made of a transparent or semitransparent material. The material of the covering element 9 can be, for example, rubber, plastic or thermoplastic elastomer. The contact surface formed by the covering element 9 is essentially smooth. Of course, the contact surface may also be fluted or it may comprise various patterns or the like in order to enable ease of use, i.e. a reliable and pleasant contact between the button array and a user's finger.

Under the covering element 9 there is arranged an array of miniature switch elements 10. The switch elements 10 are attached to a support element 11, which may be a printed circuit board, for example, or some other element supporting the switch elements 10.

The switch elements 10 may be mechanical or optical switches which are commonly known per se and are therefore not discussed in more detail here.

Adjacent switch elements 10 are arranged at distance D which has a value less than a minimum value which is suited for button activation by the user when pushing the button array 6 with a finger. In other words, the switch elements 10 are arranged at spacings which are less in value than a value which is suited for button activation by the operator when using his/her finger. Therefore, when the user presses the contact surface with his/her finger F, at least two switch elements 10 are activated. It is to be noted that the switch elements 10 are depicted with dotted lines in FIG. 2.

The width of a switch element 10, i.e. the dimension parallel to the shorter side of the button array 6, is about the same as the length of said shorter side of the button array 6. In FIG. 1 adjacent command labels 8 are arranged essentially at equal distances, i.e. the spacing between adjacent command labels 8 is the same throughout the button array 6.

The Figures show imaginary borderlines 15 between adjoining buttons 14 to clarify the fact that the button array 6 is divided into buttons 14 of an equal size. The total area of the button array 6 is utilized as the contact surface of the buttons 14. It is to be noted in this connection that the imaginary borderlines 15 are only shown in order to facilitate the understanding of the invention. In a real mobile device 1 there are no imaginary borderlines 15.

The array of switch elements 10 is also divided so that there are an equal number of switch elements 10 dedicated for each one of the commands/functions indicated in the command label area 7.

In the command label area 7 there are borderlines 16 which distinctly show where one command label ends and another one begins. It is to be noted here that the borderlines are not essential features of the command label area 7 but the area can be arranged without them.

The phone also comprises means 12 for identifying the midmost switch element(s) activated by the operator. When the operator of the mobile device 1 presses the button array 6 in order to accomplish a certain command or function shown in one of the command labels 8, then several switch elements are pressed down, i.e. activated. The means 12 for identifying the midmost switch element(s) activated by the operator then identifies the midmost switch element, or two midmost switch elements, among the activated switch elements 10 of the button array 6. In other words, the means 12 for identifying the midmost switch element(s) activated by the operator identifies where the activation centre of the button array is located. If two adjacent switch elements are identified as the midmost switch elements, the space between those two switch elements is identified as the activation centre of the button array 6. The result of the identifying task is sent to means 13 for identifying the button event associated with said midmost switch element(s), or the activation centre of the button array 6.

The means 13 for identifying the button event matches up the midmost element(s) of the activated switch elements with the closest command label 8 in the command label area 7. This can be carried out, for example, by dedicating first each one of the switch elements 10 to the closest command label 8. Next, the information from the means 12 for identifying the activated midmost switch element(s) is combined with information about the dedicated switch elements 10. Then, information on the button event corresponding to a matching command label 8 is sent to user interface software. In this connection the command label 8 may produce a visible indication, an acoustic signal, or some another indication that confirms the selected button event to the operator.

In principle, it is possible that when the operator of the mobile device 1 presses the button array 6 he/she activates e.g. two midmost switch elements dedicated to different command labels 8. Therefore, the button array 6 can be arranged so that said command labels 8 change their appearance when the button array 6 is pressed. The operator will notice this and can move his/her finger towards the command or function he/she wants to carry out. Of course, instead of a visible indication, some other indication of an erroneous activation can be given.

According to another embodiment of the invention, the information on the button event corresponding to a matching command label 8 is not sent to the user interface software until the operator lifts his/her finger from the button array 6. When the operator lifts his/her finger, the midmost elements activated last are considered to represent the command or function that the operator wants to execute, and the button event is sent to the user interface software. As the operator is pressing the button array 6, a visible indication may be shown to indicate the command or function that will be activated if the operator lifts his/her finger from the button array 6. In this way, the operator can easily control his/her selection of commands or functions by moving his/her finger on the button array 6.

It is to be noted in this connection that the user interface software is not shown in the Figures.

An optical button array 6 may be implemented for example so that there is a light source at one edge of the support element 11 and light sensitive detectors or switch elements arranged on the opposite edge of said support element. As the operator is pressing the button array 6, the light to one or more of said switch elements is blocked. The means 12 for identifying the midmost switch element(s) then identifies the midmost switch element(s) among those of those blocked switch elements in the button array 6.

The means 12 for identifying the midmost switch element(s) activated by the operator as well as the means 13 for identifying the button event associated with said midmost switch element(s) can be implemented, for example, by a software code downloaded into a processor of the phone. The software code can be transferred to the phone from an external data storage medium, as CD-ROM, or the like. It can also be transferred to the phone via an external data communication network, for example by connecting the phone to the Internet. It is also possible to use a hardware implementation or a combination of a hardware implementation and a software code.

Compared to FIG. 1, the phone in FIG. 2 employs a different application step, or a totally different application or program. There are only three commands or functions available in the button array 6.

The command labels 8a-8c indicate to the user of the phone those functions that can be carried out by the button array 6 in the current application of the phone. The topmost command label 8a, ‘Label V’, has the greatest area, or height, whereas the lowest command label 8c, ‘Label VI’, has the smallest area, or height. Accordingly, the number of switch elements 10 dedicated for the command/function indicated in the topmost command label 8a is greater than the number of switch elements 10 dedicated for the command/function indicated in the middle command label 8b, ‘Label VII’, and number of switch elements 10 dedicated for the command/function indicated in the middle command label 8b is greater than the number of switch elements 10 dedicated for the command/function indicated in the lowest command label 8c.

The area of the button array 6 as a whole is utilized as the contact surface of the buttons 14a-14c. In other words, although there are only three buttons 14a-14c in the button array 6, the total area of the contact surface of the buttons 14a-14c is equal to the total area of the contact surface of the four buttons 14 shown in FIG. 1.

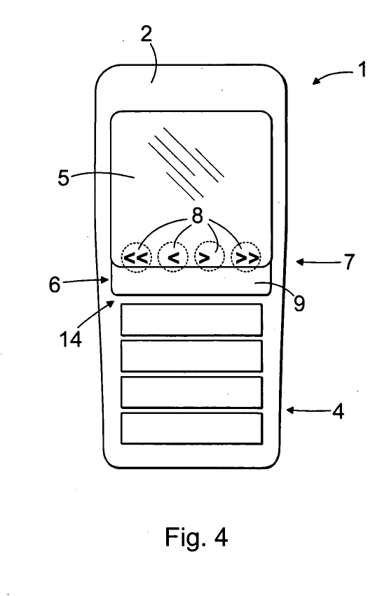

FIG. 4 is a schematic front view of a detail of another embodiment of the mobile device according to the invention. The mobile device 1 shown is a cellular phone that comprises a base part 2 with a keyboard 4 and at least one display 5 arranged thereto. Under the display 5 there is a button array 6. The structure and function of the button array 6 are essentially similar as in the button array disclosed in FIGS. 1-3. The main difference is that the button array 6 is arranged horizontally, not vertically, in the vicinity of the display 5.

It is to be noted here that the shape of the button array 6 is not limited to rectangular shapes but it may be oval, for example, or it may be shaped to extend around one or more corner(s) of the display 5. It is also possible that there are two or more button arrays 6 arranged around the display.

On the lowest part of the display 5 there is arranged an area 7 of command labels. In the command label area 7 of there are shown command labels 8 which indicate to the user of the phone those functions that can be carried out by the button array 6 in the current application of the phone. FIG. 4 shows four command labels 8 shown in the command label area 7. In other words, those four commands or functions can be executed through the button array 6 at the moment.

A desired command or function is executed by pressing the button array 6 near the command label 8 showing the symbol of said command or function. After the execution of the command or function the command labels 8 can be replaced by other labels showing commands or functions available at that moment.

For a man skilled in the art it is obvious that in the course of technical progress, the basic idea of the invention can be carried out in numerous ways. Thus, the invention and its embodiments are not limited by the previous examples but they may vary within the scope of the appended claims.

1. A button array system to be arranged in the vicinity of the display of a mobile device, said system
having predetermined dimensions, wherein
the size of the buttons in said array is arranged to be exchangeable on the basis of the purpose of use of said button array.

2. The button array system according to claim 1, wherein said array system comprises a flexible covering element which is arranged to form an outer surface of the button array.

3. The button array system according to claim 2, wherein the flexible covering element is made of a non-transparent material.

4. The button array system according to claim 1, wherein the number of buttons is arranged to be exchangeable on the basis of the application of said button array.

5. The button array system according to claim 1, wherein the total area of the contact surface of the active buttons is independent from the number of the active buttons and is essentially equal to the area of the button array.

6. A button array system having a predetermined width and height, said array comprising:
a plurality of miniature switch elements arranged at distances shorter than those suited for button activation by an operator pressing a button with his/her finger; and
means for identifying the midmost switch element(s) activated by the operator.

7. The button array system according to claim 6, further comprising means for identifying the button event associated with said midmost switch element(s).

8. The button array system according to claim 6, wherein the miniature switches are covered with a covering material.

9. The button array system according to claim 6, wherein the miniature switches are mechanical switches.

10. The button array system according to claim 6, wherein the miniature switches are optical switches.

11. A mobile device, comprising:
a display;
a button array, having a predetermined width and height, wherein the size of the buttons in said array is arranged to be exchangeable on the basis of the application of said button array,
wherein the button array is arranged in the vicinity of the display; and
wherein the display is arranged to show the labels of the commands available with the button array and the application executed in the mobile device.

12. The mobile device according to claim 11, wherein the button array comprises a flexible and continuous covering element.

13. A mobile device, comprising:
a button array having predetermined dimensions, said array comprising:
a plurality of miniature switch elements arranged at spacings which are less in value than a value which is suited for button activation by the operator when using his/her finger,
means for identifying the midmost switch element(s) activated by the operator and
means for identifying the button event associated with said midmost switch element(s).

14. A mobile device, comprising:
a button array, having predetermined dimensions, said array comprising:
a plurality of miniature switch elements arranged at distances shorter than those suited for button activation by an operator pressing a button with his/her finger,
a display arranged in the vicinity of the button array, said display being arranged to show label(s) of the commands available with the button array,
means for identifying the midmost switch element(s) activated by the operator,
wherein the size and number of buttons in said array is arranged to be exchangeable on the basis of the application of said button array.

15. A mobile device according to claim 14, wherein the mobile device is a cellular phone.

16. A mobile device according to claim 14, wherein the button array has an elongated form and is arranged vertically in the vicinity of the display.

17. A mobile device according to claim 14, wherein the button array has an elongated form and is arranged horizontally in the vicinity of the display.

18. A computer program which is loadable into the internal memory of a mobile device, the mobile device comprising a button array, having predetermined dimensions and comprising a plurality of miniature switch elements arranged at distances shorter than those suited for button activation by an operator pressing a button with his/her finger, wherein said computer program comprises a software code for identifying the midmost switch element(s) activated by the operator and for identifying the button event associated with said midmost switch element(s).

19. A computer program product comprising a computer program for a mobile device, the mobile device comprising a button array, having predetermined dimensions and comprising a plurality of miniature switch elements arranged at distances shorter than those suited for button activation by an operator pressing a button with his/her finger, wherein said computer program comprises a software code for identifying the midmost switch element(s) activated by the operator and for identifying the button event associated with said midmost switch element(s).
